(19) United States
(12) Patent Application Publication
(10) Pub. No.: US 2022/0065650 A1
(43) Pub. Date: Mar. 3, 2022

(54) Universal Pointing and Interacting Device for the Guidance of the Blind and Visually Impaired

(71) Applicant: Eyal Shlomot, Long Beach, CA (US)

(72) Inventor: Eyal Shlomot, Long Beach, CA (US)

(21) Appl. No.: 17/524,769

(22) Filed: Nov. 12, 2021

Related U.S. Application Data
(63) Continuation-in-part of application No. 16/931,391, filed on Jul. 16, 2020.
(60) Provisional application No. 63/113,878, filed on Nov. 15, 2020.
(60) Provisional application No. 63/239,923, filed on Sep. 1, 2021.

(51) Int. Cl. G01C 21/36; G06T 7/73; G06K 9/00; G06K 9/24; G06K 9/46; G06K 9/22; G01C 21/12; G01C 21/20

(52) U.S. Cl. CPC G01C 21/3626; G06T 7/73; G06K 9/00671; G06K 9/24; G06T 2207/30244; G06K 9/228; G01C 21/12; G01C 21/20; G06K 9/46

(57) ABSTRACT

This invention describes a universal pointing and interacting (UPI) device that is used for the guidance of the blind or visually impaired. The UPI device uses a camera and employs a visual positioning algorithm to determine its exact location, azimuth and orientation. Using the exact location, azimuth and orientation and utilizing information about the surroundings from a database, the UPI device provides visual-substitution capabilities to the blind or visually impaired, in scanning the surroundings, locating targets in the surroundings and walking navigation in the surroundings from a starting point to a destination point.

### CROSS-REFERENCE TO RELATED APPLICATIONS

This application is a Continuation-In-Part of U.S. patent application Ser. No. 16/931,391 filled on Jul. 16, 2020, which is hereby incorporated by reference in its entirety. This application claims priority benefits of U.S. provisional patent application Ser. No. 62/875,525 filed on Jul. 18, 2019, which is hereby incorporated by reference in its entirety. This application also claims priority benefits of U.S. provisional patent application Ser. No. 63/113,878 filed on Nov. 15, 2020, which is hereby incorporated by reference in its entirety. This application also claims priority benefits of U.S. provisional patent application Ser. No. 63/239,923 filed on Sep. 1, 2021, which is hereby incorporated by reference in its entirety.

### FIELD OF THE INVENTION

The present invention relates to a simple and practical universal pointing and interacting (UPI) device that can be used for interacting with objects in the surroundings of the user of the UPI device. In particular, the present invention describes utilizing the UPI device for the guidance of blind or visually impaired users.

### BACKGROUND ART

Advances in modern technologies contributed to the creation of electronic devices for the guidance of the blind or visually impaired, but current guidance devices do not yet provide the full capability of vision substituting for the blind or visually impaired. There are significant challenges in the design of guidance devices for the blind or visually impaired. One critical problem is the significant error, from few meters up to few tens of meters, in the estimation of the location by technologies such as GPS. Another critical problem is that current commonly used navigation apps are not designed to calculate and find a sufficiently detailed, safe and optimal walking path for the blind or visually impaired. Moreover, even if a path tailored to the needs of the blind or visually impaired is calculated by a navigation app, yet another critical problem is the difficulty in orienting the walking blind or visually impaired person to the desired direction, since a blind or visually impaired person cannot use visual cues for directional orientation, as done instinctively by a seeing person. Further, while existing guidance devices for the blind or visually impaired based on scene analysis technology can assist in guiding and safeguarding a walking blind or visually impaired person, current scene analysis technologies still lack the ability to provide full and sufficiently accurate information about obstacles and hazards in the surroundings.

U.S. patent application Ser. No. 16/931,391 describes a universal pointing and interacting (UPI) device. In particular, the operation of the UPI device uses the triangulation of known locations of objects of interest (“reference points”) to find the exact location, azimuth and orientation of the UPI device, in the same way that Visual Positioning Service/System (VPS) is used to find the exact location, azimuth and orientation of a handheld device when VPS is used, for example, in the Live View feature of Google Maps mobile app. The unique structure and features of the UPI device, combined with the data gathered by extensive photographic and geographic surveys that were carried out at all corners of the world during the last decade, may provide a significant step forward in providing vision substitution for the blind or visually impaired. Therefore, there is a need for a UPI device that provides enhanced vision substitution functionalities for the blind or visually impaired.

### BRIEF DESCRIPTION OF THE INVENTION

The present invention describes a universal pointing and interacting (UPI) device which is operating as a vision substitution device for the guidance of the blind or visually impaired. A UPI device is described in U.S. patent application Ser. No. 16/931,391 as comprising of several sensing, processing and communication components. A key component for the operation of the UPI device is its forward-facing camera. Using triangulations of the locations of identified objects of interest (“reference points”) captured by the camera and aided by measurements from accelerometer/gyroscope/magnetometer and GPS information, it is possible to obtain very precise estimates of the location, azimuth and orientation the UPI device. Combining the precisely estimated location, azimuth and orientation parameters of the UPI device with detailed data about the surroundings obtained by extensive photographic and geographic surveys carried out all over the world and stored in accessible databases, the UPI device can provide the most advanced vision substitution solution for all aspects of guiding the blind or visually impaired in the surroundings.

The location of the UPI device is estimated precisely and therefore the device may operate as a precise Position Locator Device (PLD) by simply providing information about the user's location, such as a street address. The combination of the precise location and the direction the UPI device is pointing (azimuth and orientation), the UPI device may be used as the ultimate Electronic Orientation Aid (EOA) in assisting the blind and visually impaired to walk from a starting point to a destination point. The precise location and pointing direction of the UPI device, combined with the tabulated information about the surroundings and possibly further employing the camera and a proximity detector, the UPI device may provide unparallel performance as an Electronic Travel Aid (ETA) device that provides the user with information about the immediate and nearby surroundings for safe and efficient movement.

In particular, this invention describes 3 procedures for operating the UPI device by its blind or visually impaired users. One procedure is “scanning”, where the user can receive information about objects of interest in the surroundings as the user holds UPI device in a horizontal position and moves it around. This is equivalent to the way a seeing person becomes familiar with new surroundings when rounding a street corner, exiting a building or disembarking a bus or a train. A second procedure is “locating”, in which the UPI device provides the general indication of the direction of a specific target. A third procedure is “navigating”, in which the UPI device provides exact walking directions from a current location to a specific destination to the blind or visually impaired user. Obviously, these 3 procedures may be used interchangeably as a blind or visually impaired person is interacting with and moving in the surroundings.

### BRIEF DESCRIPTION OF THE DRAWINGS

The features and advantages of the present invention will become more readily apparent to those ordinarily skilled in the art after reviewing the following detailed description and accompanying drawings, wherein:

FIG. 1A is a schematic diagram schematic diagram of a full and independent UPI device.

FIG. 1B is a schematic diagram schematic diagram of a simplified UPI Device.

FIG. 2A is a schematic diagram an operational configuration for a UPI device.

FIG. 2B is a schematic diagram of an operational configuration for a simplified UPI device.

FIG. 3 is a schematic flowchart of a scanning procedure, with user actions on the left and UPI device actions on the right.

FIG. 4 is a schematic flowchart of a locating procedure, with user actions on the left and UPI device actions on the right.

FIG. 5 is a schematic flowchart of a navigating procedure, with user actions on the left and UPI device actions on the right.

### DETAILED DESCRIPTION OF THE INVENTION

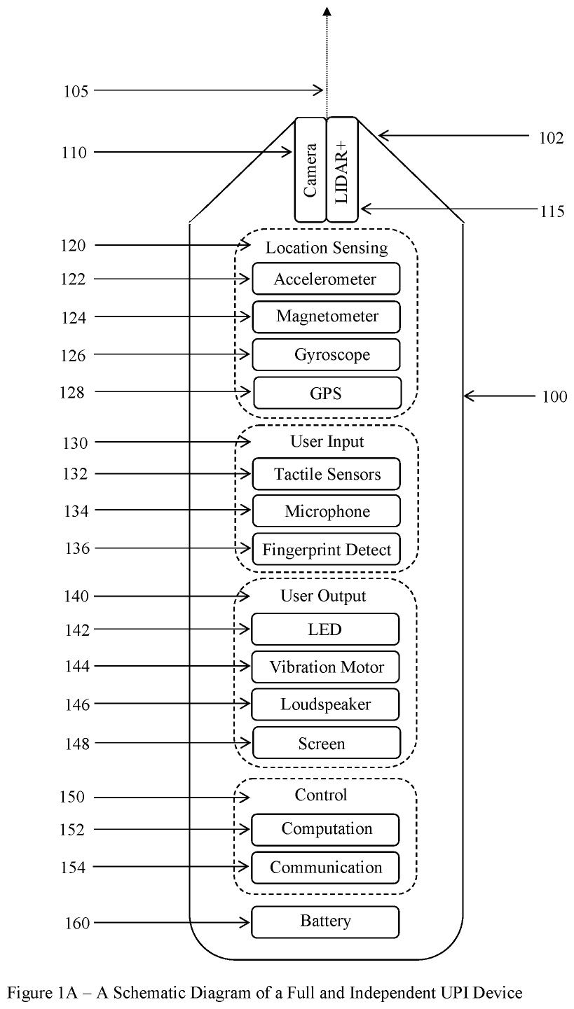

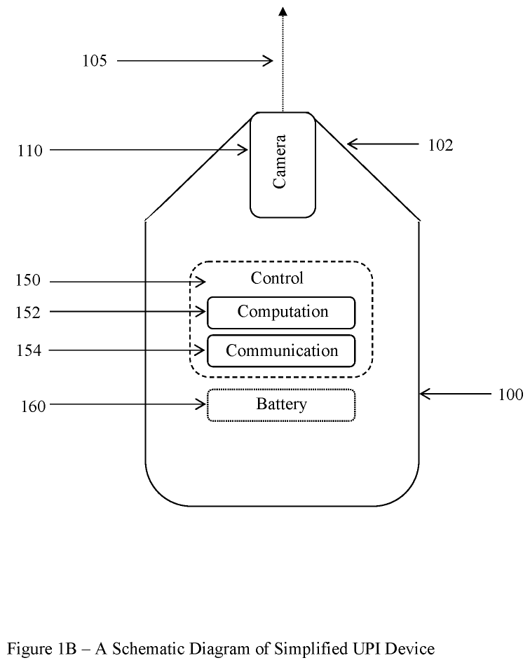

FIG. 1A describes a full and independent universal pointing and interacting (UPI) device 100. The components of UPI device 100 in FIG. 1A correspond to the components of the UPI device described in FIG. 1 of U.S. patent application Ser. No. 16/931,391. Such UPI device 100 comprises of an elongated body similar to a wand or a stylus. Tip 102 of UPI device 100 is the frontal end of the longest dimension of the elongated body of UPI device 100 and the main axis of UPI device 100 is the axis of longest dimension of the elongated body of UPI device 100. Pointing ray 105 is an indefinite extension of the main axis of UPI device 100 in the frontal direction from tip 102 of UPI device 100. Camera 110 and LIDAR+ 115 are positioned at tip 102 of UPI device 100. LIDAR+ 115 is any type of LIDAR device, single-beam or multi-beam, or it can be any other distance measuring device that may be based on other technologies, such as ultrasound or radar. UPI device 100 may also be of any shape, other than an elongated body, that is suitable to be held by hand, clipped on eyeglasses frames, strapped to the user head (e.g., attached to a hat, visor or headband), attached to any part of the user body, or shaped as part of a ring, where the frontal direction of UPI device 100 that forms pointing ray 105 is the direction the camera of UPI device 100 is facing. UPI device 100 further includes location sensing components 120, user input components 130, user output components 140, control components 150, and battery 160. Location sensing components 120 includes accelerometer 122, magnetometer 124 and gyroscope 126, as well as GPS 128. User input components 130 includes tactile sensors 132 (e.g., switches, slides, dials or other touch sensors), microphone 134 and fingerprint detection sensor 136. User output components 140 includes light emitting diode (LED) 142, vibration motor 144, loudspeaker 146 and screen 148. Control components 150 includes computation component 152 and communication component 154.

Input components 130 and output components 140 facilitate the user interaction with UPI device 100. Specifically, if UPI device 100 is designed to be held by a hand, it may have one side that is mostly used facing up and an opposite side that is mostly used facing down. Tactile sensors 132 and fingerprint detection sensor 136 are placed on the outer shell of UPI device 100 in suitable locations that are easily reachable by the fingers of the user, for example, at the “down” side. LED 142 (or several LEDs) are also placed on the outer shell of UPI device 100 in suitable locations to be seen by the user, for example, at the “up” side. Screen 148 may also be placed on the outer shell of UPI device 100 at the “up” side. Vibration motor 144 is placed inside UPI device 100, preferably close to the area of UPI device 100 where the user is holding the device. Moreover, two units of vibration motor 144 may be used, each placed in each edge of UPI device 100, which can be used to create rich vibration patterns for the user of UPI device 100. Microphone 134 and loudspeaker 146 are placed for optimal receiving of audio and playing of audio from/to the user, respectively.

As was discussed in U.S. patent application Ser. No. 16/931,391, UPI device 100 depicted in FIG. 1A can operate as an independent device. However, as UPI device 100 is more likely to operate together with a handheld device, such as a cellphone or a tablet, some of the components of UPI device 100 are not essential. For example, GPS 128 may not be essential, as the general location of UPI device 100 may be obtained from the location information of the handheld device if UPI device 100 is operating together with that handheld device. FIG. 1B describes a simplified option for the structure of UPI device 100, which includes the key elements of camera 110 and control components 150 that transmit the images captured by camera 110 to the handheld device. Even battery 160 may be eliminated if UPI device 100 is connected by a cable to the handheld device. UPI device 100 can have any configuration between the full and independent configuration depicted in FIG. 1A and the simplified configuration depicted in FIG. 1B. Obviously, in any configuration that is not the full and independent configuration depicted in FIG. 1A, UPI device 100 will be operating together with a handheld device and therefore the description of the operation of UPI device 100 may also be considered as a description of the operation of UPI device 100 that is operating together with that handheld device, as discussed below.

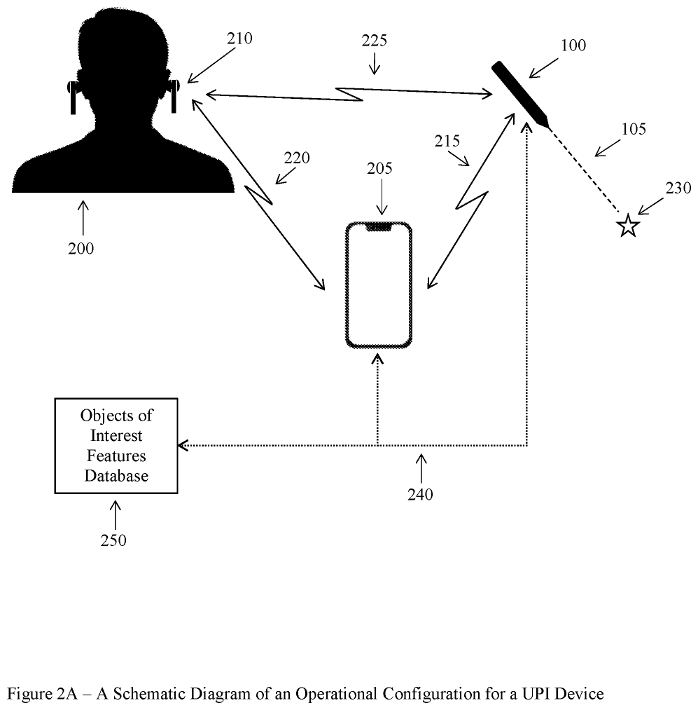

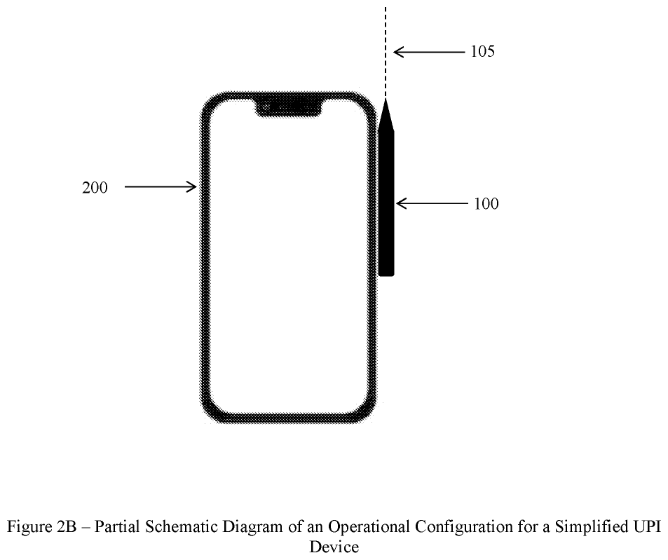

FIG. 2A shows an optional operational configuration for UPI device 100 where user 200 of UPI device 100 also uses handheld device 205 (e.g., smart-phone, tablet, etc.) and optionally also earbuds 210 that may include a microphone. Wireless connections 215, 220 and 225 connect UPI device 100, handheld device 205 and earbuds 210, based on the desired configuration, and are commonly Bluetooth or Wi-Fi connections, but any other wireless or wireline connection protocol may be used. Wireless connections 215, 220 and 225 enable the shared operation of UPI device 100 together with handheld device 205 and earbuds 210. One element of the shared operation is the user interaction, by receiving inputs from user 200 by input elements on handheld device 205 or earbuds 210 (in addition to receiving inputs by user input components 130 on UPI device 100) and by providing outputs to user 200 by output elements on handheld device 205 or earbuds 210 (in addition to providing outputs by user output components 140 on UPI device 100). Another element of the shared operation is the sharing of measurements, such as using the GPS information of handheld device 205 for the operation of UPI device 100, while yet another element is the sharing of the computation loads between UPI device 100 and handheld device 205. Communication link 240 provides the means for UPI device 100 or handheld device 205 to connect with features database 250 that holds the features of objects of interest 230, where the features are the location information of objects of interest 230, visual description of objects of interest 230, as well as other information about objects of interest 230 (e.g., opening hours and a menu if a particular object of interest 230 is a restaurant). Wireless connections 215, 220 and 225 depicted in FIG. 2A may be implemented using a wire connection, as earbuds 210 may be replaced with headphones connected by a wire to handheld device 205 or a wire may be used to connect between UPI device 100 and handheld device 205.

U.S. patent application Ser. No. 16/931,391 describes the identification of objects of interest 230 that are pointed at by UPI device 100, such that information about these objects is provided to the user. This identification of objects of interest 230 and providing that information is also critical for the blind or visually impaired, but additional operating procedures of UPI device 100 for the blind or visually impaired are the scanning of the surroundings, the locating of targets in the surroundings, as well as the navigating in the surroundings to a specific destination. To perform these operating procedures, it is critical to know the exact location of the UPI device 100 and its exact pointing direction, i.e., its azimuth and orientation. Current navigation devices (or apps on handheld devices) mainly use the GPS location information, but the error in the GPS location information is a few meters in typical situations and the error can be significantly larger in a dense urban environment. Current navigation devices may use a magnetometer to estimate the azimuth, but a typical magnetometer error is about 5° and the error can be significantly larger when the magnetometer is near iron objects. Obviously, these accuracies are insufficient for the guidance of the blind or visually impaired uses.

The discussion of the operation of UPI device 100 in U.S. patent application Ser. No. 16/931,391 includes the description of a procedure that finds the exact location, azimuth and orientation of UPI device 100 by capturing images by camera 110. This procedure includes identifying several objects of interest 230 in the surroundings that their locations and visual descriptions are known and tabulated in features database 250 and obtaining highly accurate estimation of the location, azimuth and orientation of UPI device 100 by triangulation from the known locations of these identified objects of interest 230. This visual positioning procedure is identical to currently available commercial software, and specifically to the Visual Positioning Service/System (VPS) developed by Google. To avoid confusion and to align this patent application with currently published technical literature, it is important to emphasis that objects of interest 230 in U.S. patent application Ser. No. 16/931,391 comprise of two types of objects. One type of objects of interest 230 are objects that are needed for the visual position procedure, which are of very small dimension (e.g., a specific window corner) and are usually called “reference points” in the literature. The features of these reference points that are stored in features database 250 include mostly their locations and their visual description. Other type of objects of interest 230 are in general larger objects (e.g., a commercial building) and their features that are stored in features database 250 may include much richer information (e.g., commercial businesses inside building, opening hours, etc.).

In general terms, there are 3 procedures that are performed by a seeing person for orientation and navigation in the surroundings. The first procedure is “scanning”, which is performed when a person arrives to a new location, which happens, for example, when a person turns a street corner, exits a building or disembarks a vehicle. The second procedure is “locating”, which is performed when a person is interested in locating a particular object or landmark in the surroundings, such as a street address, an ATM or a bus stop. The third procedure is “navigating”, which is the controlled walking from a starting point to a destination end point. To perform these procedures, a seeing person is using visual information to determine the person location and orientation. Obviously, a seeing person seamlessly and interchangeably uses these 3 procedures in everyday activities. We will describe how a blind or visually impaired person can use UPI device 100 to perform each of these procedures.

The scanning procedure is performed by holding UPI device 100 and moving it along an approximated horizontal arc that covers a sector of the surroundings. As UPI device 100 is estimating its location and as it is moved along an approximated horizontal arc its azimuth and orientation are continuously updated and therefore it can identify objects of interest 230 in its forward direction as it is moved. UPI device 100 can provide audio descriptions to the user about objects of interest 230 at the time they are pointed at by UPI device 100 (or sufficiently close to be pointed at), based on data obtained from features database 250. The scanning procedure is initiated by touch or voice commands issued when the user wants to start the scanning, or simply by self-detecting that UPI device 100 is held at an approximated horizontal position and then moved in an approximated horizontal arc. Moreover, as UPI device 100 is fully aware of its location, UPI device 100 can also be configured to alert the user about a change in the surroundings, such as rounding a corner, to promote the user to initiate a new scanning process.

A typical urban environment contains numerous objects of interest and a seeing person who is visually scanning the surroundings may instinctively notice specific objects of interest at suitable distances and of suitable distinctions to obtain the desired awareness of the surroundings. While it is difficult to fully mimic such intuitive selection by UPI device 100, several heuristic rules may be employed for an efficient and useful scanning procedure for the blind or visually impaired users. One rule can be that audio information should be provided primarily about objects that are in line-of-sight of UPI device 100 and that are relatively close. Another rule may limit the audio information to objects that are more prominent or more important in the surroundings, such as playing rich audio information about a building of commercial importance pointed at by UPI device 100, while avoiding playing information about other less significant buildings on a street. Yet another rule can be the control of the length and depth of the audio information based on the rate of motion of UPI device 100 along the approximated horizontal arc, such that the user may receive less or more audio information by a faster or slower horizontal motion of UPI device 100, respectively. Obviously, the parameters of these rules may be selected, set and adjusted by the user of UPI device 100. The audio information can be played by earbuds 210, loudspeaker 146 or the loudspeaker of handheld device 205, and can be accompanied by haptic outputs from vibration motor 144, or by visual outputs on screen 148 or on the screen of handheld device 205. The presentation of the audio information can be controlled by the motion of UPI device 100, by touch inputs on tactile sensors 132, or by voice commands captured by a microphone on earbuds 210, microphone 134 or the microphone of handheld device 205. For example, a short vibration may indicate that UPI device 100 points to an important object of interest and the user may be able to start the playing of audio information about that object by holding UPI device 100 steady, touching a sensor or speaking a command. Similarly, the user can skip or stop the playing of audio information by moving UPI device 100 further, touching another sensor or speaking another command.

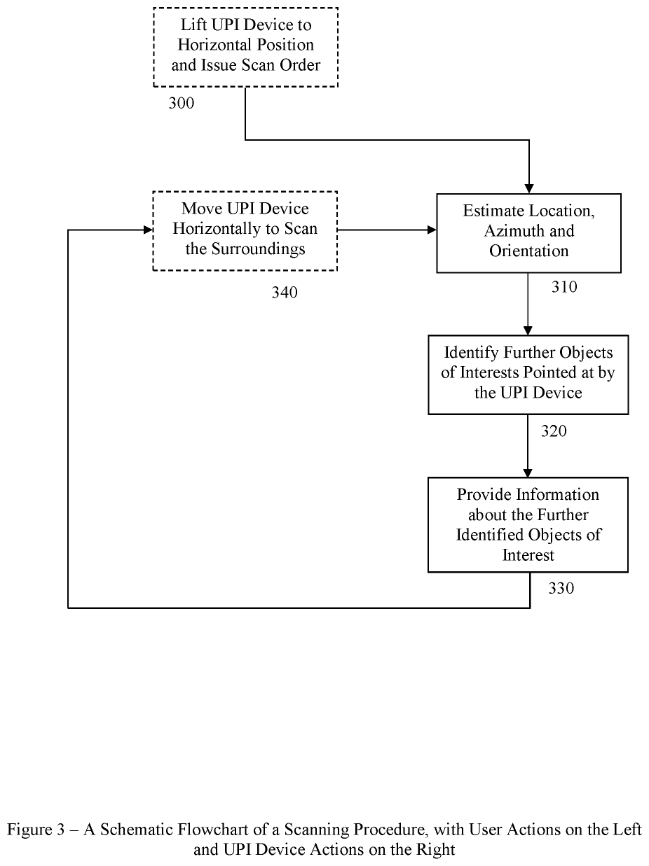

FIG. 3 is a schematic flowchart of the scanning procedure performed by a blind or visually impaired person using UPI device 100. The actions taken by the user of UPI device 100 are on the left side of FIG. 3, in dashed frames, while the actions taken by UPI device 100 are on the right side of FIG. 3, in solid frames. In step 300, the user lifts UPI device 100 to horizontal position and issues a command to UPI 100 to start a scanning procedure. The issuing of the command may be explicit, such as by any of tactile sensors 132 or by a voice command, or may be implicit by holding UPI device 100 stable in a horizontal position, which may be recognized by UPI device 100 as the issuing of the scan command. UPI device 100 receives or identifies the scan command and estimates its exact location, azimuth and orientation in step 310. The exact estimation procedure was described in U.S. patent application Ser. No. 16/931,391 and it uses the initial location information obtained by GPS signals, the initial azimuth generated from measurements by magnetometer 124, the initial orientation generated from measurements by accelerometer 122 and a frontal visual representation generated by processing an image captured by camera 110, to identify a set of objects of interest 230 (“reference points”) in the surroundings. The identification is performed by a comparison (using correlation) of the content of the frontal visual representation with the visual description of objects of interest 230 in the surroundings. Obviously, the initial location information is the key parameter that helps to narrow performing the comparison process only for objects of interest 230 that are in the surroundings, while not performing the comparison process for objects of interest 230 elsewhere. The initial azimuth and the initial orientation further assist in narrowing the performing the comparison process only for objects of interest 230 that are in a specific sector of the surroundings, while not performing the comparison process for objects of interest that are not in that sector. Once such set of objects of interest 230 is identified, the locations of these identified objects of interest 230 are obtained from database 250 and the exact location, azimuth and orientation of UPI device 100 is estimated using triangulation of the obtained locations of these identified objects of interest 230. In step 320 UPI device 100 identifies further objects of interest 230 in the surroundings as further objects of interest 230 that are pointed at pointing ray 105, i.e., objects of interest 230 that are in line-of-sight and that pointing ray 105 passes within a predetermined distance to them. Note that the further identified objects of interest 230 may be different than the set of objects of interest 230 (“reference points”) that were identified for the estimation of the exact location, azimuth and orientation of UPI device 100 in step 310. UPI device 100 then provides information about the further identified objects of interest 230 to the user in step 330. As the user moves UPI device 100 in horizontal direction to scan the surroundings in step 340, UPI device 100 continuously further estimates its location, azimuth and orientation and repeats steps 320 and 330.

The following three examples demonstrate some superior aspects of scanning the surroundings by UPI device 100 over visual scanning of the surroundings by a seeing person. In the first example, UPI device 100 may also provide audio information about objects of significant importance in the surroundings, such as a mall, a landmark, a transportation hub or a house of warship, that might be very close but not in the direct line-of-sight of UPI device 100 (e.g., just around a corner). In the second example, the audio information about the pointed-at objects of interest 230 may include details that are not visible to a seeing person, such as lists of shops and offices inside a commercial building, or operating hours of a bank. In the third example it is assumed that UPI device 100 is pointed to a fixed alphanumeric information in the surroundings (such as street signs, stores and building names, informative or commemoration plaques, etc.). As the locations and the contents of most alphanumeric information in the public domain are likely to be tabulated in and available from features database 250, the alphanumeric information may be retrieve from features database 250, converted to an audio format and provided to the user of UPI device 100 regardless of the distance, the lighting or the viewing-angle of the alphanumeric information.

A seeing person may intuitively locate a specific target in the surroundings, such as an ATM, a store or a bus stop. Blind or visually impaired users of UPI device 100 are able to initiate a locating procedure for particular targets, such as “nearest ATM”, using a touch or voice-activated app on handheld device 205, or, alternatively, by a touch combination of tactile sensors 132 on UPI device 100. The app or UPI device 100 may then provide the blind or visually impaired user with information about the target, such as the distance to and the general direction of the target, or any other information about the target such as operating hours if the target is a store, an office or a restaurant. If the user of UPI device 100 is only interested in reaching that specific target, the next step is to activate a navigating procedure, which is described further below, and to start walking toward the target. It is possible, however, that the user of UPI device 100 may want to know the general direction of a specific target or the general directions of several targets to be able to choose between different targets. To get an indication of the general direction of a specific target the user may lift UPI device 100 and point it to any direction, which will allow UPI device 100 to obtain current and accurate estimates of its location, azimuth and orientation. Once these estimates are obtained, UPI device 100 may use several method to instruct the user to manipulate the pointing direction of UPI device 100 toward the target, such as using audio prompts as “quarter circle to your left and slightly upward”, playing varying tones to indicate closeness or deviation from the desired direction, or using vibration patterns to indicate closeness or deviation from the desired direction.

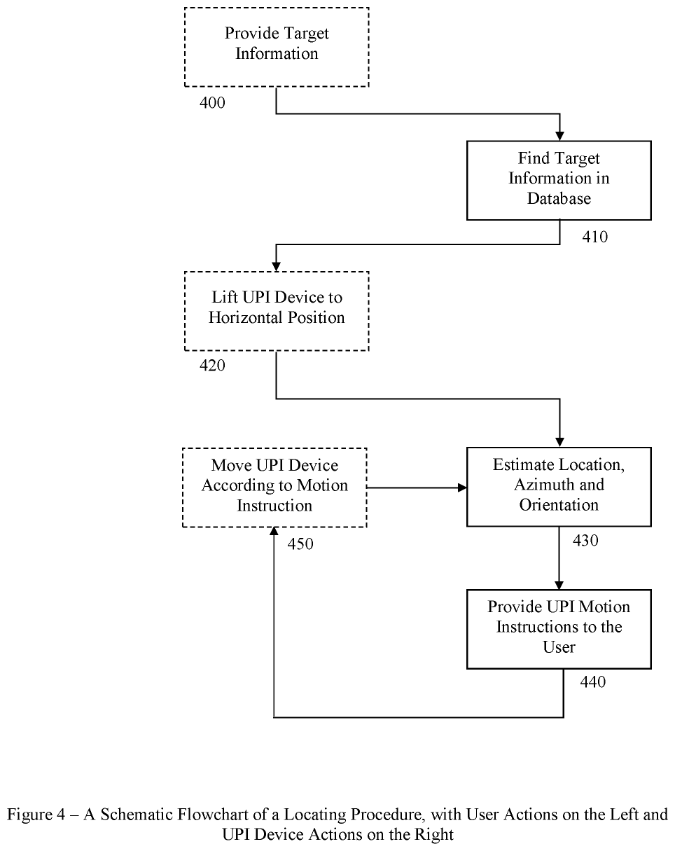

FIG. 4 is a schematic flowchart of the locating procedure performed by a blind or visually impaired person using UPI device 100. The actions taken by the user of UPI device 100 are on the left side of FIG. 4, in dashed frames, while the actions taken by UPI device 100 are on the right side of FIG. 4, in solid frames. In step 400, the user provides the target information, such as “City Museum of Art” or “nearest ATM”. In step 410, UPI device 100 finds the target information in features database 250 of objects of interest 230. Note that UPI device 100 always has the general information about its location, using its GPS device 128 or the GPS data of handheld device 200, which allows it to find distances relative to its location, such as the nearest ATM. As the target information is found, in step 420 the user lifts UPI device 100 to horizontal position. In step 430 UPI device 100 estimates its exact location, azimuth and orientation, as described above in the discussion of FIG. 3. Once the exact location, azimuth and orientation of UPI device 100 are estimated, in step 440 UPI device 100 provides motion instructions to the user on how to move UPI device 100 such that UPI device 100 is pointing closer and closer to the direction of the target. In step 450 the user moves UPI device 100 according to the instructions. UPI device 100 then repeats the estimates its exact location, azimuth and orientation and provides further motion instructions to the user in steps 430 and 440, respectively. Obviously, when UPI 100 points directly to the target, UPI device 100 informs the user of the successful completion of the locating procedure.

Targets may be stationary targets, but can also be moving targets that their locations are known, such as vehicles that make their locations available (e.g., buses, taxies or pay-ride vehicles) or people that carry handheld devices and that consensually make their locations known. For example, a seeing person may order a pay-ride vehicle using an app and will follow the vehicle location on the app's map until the vehicle is close enough to be seen, where at that point the seeing person will try to visually locate and identify the vehicle (as the make, color and license plate information of pay-ride vehicles are usually provided by the app). As the vehicle is recognized and is approaching, the seeing person may raise a hand to signal to the driver and might move closer to the edge of the road. A blind or visually impaired person may be able to order a pay-ride vehicle by voice activating a reservation app and may be provided with audio information about the progress of the vehicle, but will not be able to visually identify the approaching vehicle. However, using UPI deice 100, as the location of UPI device 100 is known exactly and as the location of the pay-ride vehicle is known to the app, once the vehicle is sufficiently close to be seen, UPI device 100 may prompt the user to point it in the direction of the approaching vehicle such that an image of the approaching vehicle is captured by camera 110. The image of the approaching vehicle may then be analyzed to identify the vehicle and audio information (such as tones) may be used to help the user in pointing UPI device 100 at the approaching vehicle, such that updated and accurate information about the approaching vehicle may be provided to the user of UPI device 100. Obviously, the same identifying and information providing may be used for buses, trams, trains and any other vehicle with a known position. In yet another example, a seeing person may be able to visually spot a friend at some distance on the street and to approach that friend, which is impossible or difficult for a blind or visually impaired person. However, assuming that friends of a blind or visually impaired person allow their locations to be known using a special app, once such a friend is sufficiently close to the user of UPI device 100, the user of UPI device 100 may be informed about the nearby friend and the user may be further assisted in aiming UPI device 100 in the general direction of that friend.

UPI device 100 can also operate as a navigation device to guide a blind or visually impaired user in a safe and efficient walking path from a starting point to a destination point. Walking navigation to a destination is an intuitive task for a seeing person, by seeing and choosing the destination target, deciding on a path to the destination and walking to the destination while avoiding obstacles and hazards on the way. Common navigation apps in handheld devices may assist a seeing person in identifying a walking destination that is further and not in line-of-sight, by plotting a path to that destination and by providing path instructions as the person walks, where a seeing person is able to repeatedly and easily compensate and correct the common but slight errors in the navigation instructions. Assisted navigation for blind or visually impaired users of UPI device 100 is a complex procedure of consecutive steps that need to be executed to allow accurate and safe navigation from the location of the user to the destination. This procedure differs from the navigation by a seeing person who is helped by a common navigation app on a handheld device. Unlike the very general walking directions provided by a common navigation app, assisted navigation for the blind or visually impaired needs to establish a safe and optimal walking path tailored to the needs of the blind or visually impaired, and to provide precise guidance through the established walking path, while detecting and navigating around obstacles and hazards.

The navigating procedure starts with the choice of a walking destination using a navigation app, which may be performed by a blind or visually impaired person using voice commands or touch commands, as described above for the locating procedure. Once the walking destination and its location are established, the location of the user needs to be determined. An approximated location of the user may be obtained using GPS signals, but a more accurate location can be established by pointing UPI device 100 to any direction in the surroundings to obtain an estimation of the location by visual triangulations. (As some pointing directions may provide more reference points for more accurate visual triangulation, UPI device 100 may use voice prompts, tones or vibrations to instruct the user to point toward an optimal direction for improved estimation of the user location.) UPI device 100 may then inform the user about the accuracy of the estimation such that the user is aware of the expected accuracy of the navigation instructions. Once a sufficiently accurate (or best available) estimation of the user location is obtained, a navigation route from the user location to the location of the walking destination is planned and calculated. A specific route for blind or visually impaired users should avoid or minimize obstacles and hazards on the route, such as avoiding steps, construction areas or narrow passages, or minimizing the number of street crossings. The specific route should steer the user of UPI device 100 away from fixed obstacles, such as lampposts, street benches or trees, where the data about such fixed obstacles may be obtained from features database 250. Further, current visual data from CCTV cameras may show temporary obstacles, such as tables placed outside of a restaurant, water puddles after the rain or a gathering of people, and that visual data may be used to steer the user of UPI device 100 away from these temporary obstacles. In addition to considering the safety and the comfort of the blind or visually impaired user of UPI device 100, the route planning may also take into account the number and the density of reference points for visual triangulations along the planned walking route, such that the estimation of the user location and direction can be performed with sufficient accuracy throughout the walking route.

A seeing person may simply walk along the navigation route and use visual cues for directional orientation and for following the route, which is not possible for a blind or visually impaired person. Instead, the pointed structure UPI device 100 (e.g., its elongated body) may be used to indicate the walking direction for the blind or visually impaired users of UPI device 100. To start the walk, the user may hold UPI device 100 horizontally at any initial direction and UPI device 100 will then provide voice prompts, varying tones or vibrating patterns to guide the user in pointing UPI device 100 to the correct walking direction, as described above for the locating procedure. As the user walks, voice prompts, varying tones or vibrating patterns (or combination of these) may be continuously used to provide walking instructions, warnings of hazards and turns, guiding the correct position of UPI device 100, or providing any other information that makes the navigation easier and safer. UPI device 100 can use the data in features database 250 to safely navigate the user around fixed obstacles, but it may also use the information from camera 110 or LIDAR+ 115 to detect temporary obstacles, such as a trash bin left on the sidewalk or a person standing on the sidewalk, and to steer the user of UPI device 100 around these obstacles.

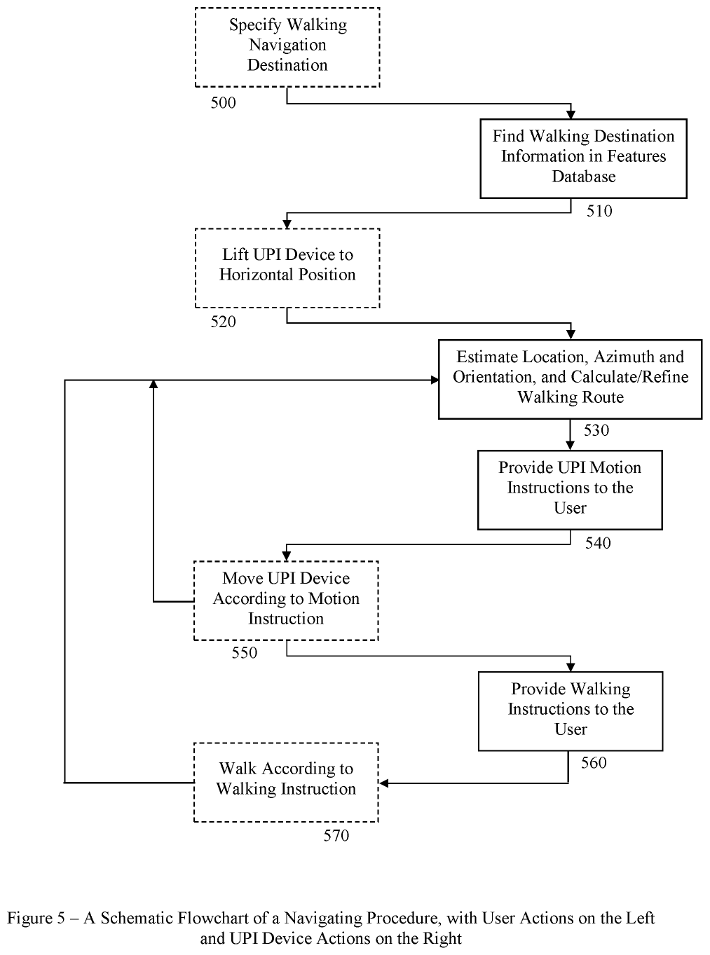

FIG. 5 is a schematic flowchart of the navigating procedure performed by a blind person using UPI device 100. The actions taken by the user of UPI device 100 are on the left side of FIG. 5, in dashed frames, while the actions taken by UPI device 100 are on the right side of FIG. 5, in solid frames. In step 500, the user specifies the walking destination, such as “Main Mall” or “nearest Italian restaurant”. In step 510, UPI device 100 finds the walking destination information in database 250. As the walking destination information is found, at step 520 the user lifts UPI device 100 to horizontal position. At step 530 UPI device 100 estimates its exact location, azimuth and orientation (as described above in the discussion of FIG. 3), and calculates or refines a walking route from the location of the user of UPI device 100 to the walking destination. Once the exact location, azimuth and orientation of UPI device 100 are estimated and the walking route is calculated or refined, UPI device 100 provides motion instructions to the user on how to move UPI device such that UPI device 100 will point closer and closer toward the walking direction in step 540. As the user moves UPI device 100 according to the instructions in step 550, UPI device 100 repeats the estimates of its location, azimuth and orientation and providing further motion instructions to the user in steps 530 and 540, respectively. Once UPI device 100 points directly to the walking direction, it can inform the user that it is now pointing to the correct walking direction. As UPI device 100 now points to the correct walking direction, at step 560 UPI device 100 provides the user with walking instructions, such as “walk forward 20 meters”, which the user performs in step 570. As the user walks, UPI device 100 repeats the estimates its location, azimuth and orientation and the refinement of the walking route in step 530 and, as needed, steps 540, 550, 560 and 570 are repeated.

Scene analysis is an advanced technology of detecting and identifying objects in the surroundings and is already employed in commercial visual substitution products for the blind or visually impaired. Scene analysis algorithms use images from a forward-facing camera (usually attached to eyeglasses frames or head-mounted) and provide information describing the characteristics of the scene captured by the camera. For example, scene analysis may be able to identify whether an object in front of the camera is a lamppost, a bench or a person, or whether the path forward is smoothly paved, rough gravel or a flooded sidewalk. Scene analysis employs features extraction and probability-based comparison analysis, which is mostly based on machine learning from examples (also called artificial intelligence). Unfortunately, scene analysis algorithms are still prone to significant errors and therefore the accuracy of scene analysis may greatly benefit from the precise knowledge of the camera location coordinates and the camera angle. Using the camera location and angle may allow a more precise usage of the visual information captured by the camera in the scene analysis algorithms. In one example, fixed objects in the surroundings can be analyzed or identified beforehand, such that their descriptions and functionalities are stored in features database 250, which may save computation from the scene analysis algorithms or increase the probability of correct analysis of other objects. In another example of identifying whether an object in front of the camera is a lamppost, a bench or a person, a scene analysis algorithm may use the known exact locations of the lamppost and the bench in order to improve the identification that a person is leaning on the lamppost or is sitting on the bench. In yet another example, if it is known that camera 110 of UPI device 100 is pointing toward the location of sidewalk water drain, the probability of correctly detecting a water puddle accumulated during a recent rain may be greatly improved, such that the navigation software may steer the blind or visually impaired user away from that water puddle. Moreover, using the pre-captured visual and geographical information in features database 250, possibly with the multiple current images captured by camera 110 of the walking path in front of the user as the user walks forward, a 3D model of the walking path may be generated and the user may be steered away from uneven path or from small fixed or temporary obstacles on the path.

An interesting and detailed example of combining information from several sources is the crossing of a street at a zebra-crossing with pedestrian traffic lights. Using the accurate location estimation, UPI device 100 may lead the blind or visually impaired user toward the crossing and will notify the user about the crossing ahead. Moreover, the instruction from UPI device 100 may further include details about the crossing structure, such as the width of the road at the crossing, the expected red and green periods of the crossing traffic light, the traffic situation and directions, or even the height of the step from the sidewalk to the road. Pedestrian traffic lights may be equipped with sound assistance for the blind or visually impaired, but regardless of whether such equipment is used, UPI device 100 may direct the user to point it toward the pedestrian crossing traffic lights and may be configured to identify whether the lights are red or green and to notify the user about the identified color. Alternatively, the color of the traffic lights may be transmitted to UPI device 100. Once the crossing traffic lights change from red to green, UPI device 100 may inform the user about the lights change and the user may then point UPI device 100 toward the direction car traffic approaches the crossing. The image captured by camera 110 and the measurements by LIDAR+ 115 may then be analyzed to detect whether cars are stopped at the crossing, no cars are approaching the crossing or safely decelerating cars are approaching the crossing, such that it is safe for the user to start walking into the crossing. On the other hand, if that analysis detects that a car is moving unsafely toward the crossing, the user will be warned not to walk into the crossing. Traffic information may also be transmitted to and utilized by UPI device 100 from CCTV cameras that are commonly installed in many major street junctions. As the user crosses the road, UPI device 100 may inform the user about the progress, such as the distance or the time left to complete the crossing of the junction. In a two-ways road, once the user reaches the center of the junction, UPI device 100 may indicate the user to point it to the other direction to be able to analyze the car traffic arriving from that direction. As the user reaches the end of the crossing, UPI device 100 may indicate the completion of the crossing and may provide the user with additional information, such as the height of the step from the road to the sidewalk.

The usage of camera 110 was described above in visual triangulations to obtain exact estimations of the location, azimuth and ordination of UPI device 100 and in scene analysis to better identified and avoid obstacles and hazards and to provide richer information about the surroundings. Further, similar to currently available products for the blind or visually impaired that include forward-looking camera, camera 110 may also be used to allow the blind or visually impaired users of UPI device 100 to share an image or a video with a seeing person (e.g., a friend or a service person) who can provide help to the users of UPI device 100 by explaining an unexpected issue, such as roadblocks, constructions or people gathering. Moreover, in addition to the image or the video, UPI device 100 may also provide the seeing person with its exact location and the direction it points to, which can be used by the seeing person to get a much better understanding of the unexpected issue by using additional resources, such as emergency service resources or viewing CCTV feeds from the exact surroundings of the user of UPI device 100.

Several operation methods were described above in using UPI device 100 for visual substitution for the blind or visually impaired. It was shown that the unique information gathering and connectivity of UPI device 100 may be able to provide the blind or visually impaired with information that is not available for a seeing person, such as operating hours of businesses, reading of signs without the need to be in front of the signs, or noticing a nearby friend. Obviously, seeing people may also benefit for these features of UPI device 100. Moreover, several other functions may be performed by UPI device 100 for the benefit of seeing people. Most interestingly, UPI device 100 may be used as an optical stylus, as discussed extensively in U.S. patent application Ser. No. 16/931,391. In another example, the image or video captured by camera 110 may be displayed on the screen of handheld device 205 and used for inspecting narrow spaces or to capture a selfie image. Further, video calls using the front-facing camera of handheld device 205 (or a webcam of a laptop computer) are extensively used for personal and business communications, as well as for remote learning. During such video calls it is common to want to show an object that is outside the field view of the camera used for the call, such as drawings on a book page or on a whiteboard, or a completed handwritten mathematical exercise. In such cases, instead of bothering to move the object to the field view of the camera used for the video call (e.g. the camera of handled device 205), the user of UPI device 100 can simply aim camera 110 of UPI device 100 toward the object, such that camera 110 may capture an image or video feed of that object, which can then be sent to the other side of the video call. The video feed from camera 110 can replace the video feed from the front-facing camera of handheld device 205 (or the video feed from a webcam of a laptop computer) or both video feeds may be combined using a common picture-in-picture approach.

1. A method of scanning the surroundings with a universal pointing and interacting (UPI) device, the method comprises:
receiving a scanning command from a user of the UPI device;
obtaining a general location of the UPI device using GPS signals;
capturing at least one image by a camera facing a frontal direction of the UPI device;
processing the captured at least one image to generate a frontal visual representation for the UPI device;
identifying a first at least one object of interest in the surroundings based on the obtained general location of the UPI device and the generated frontal visual representation for the UPI device;
obtaining at least one location of the identified first at least one object of interest from a features database;
estimating a location, an orientation and an azimuth of the UPI device based on the obtained at least one location of the identified first at least one object of interest;
identifying a second at least one object of interest in the surroundings based on the estimated location, orientation and azimuth of the UPI device;
obtaining features of the identified second at least one object of interest from the features database;
providing information to the user of the UPI device based on the obtained features of the identified second at least one object of interest.

2. The method of claim 1, further comprising:
measuring acceleration parameters of the UPI device by an accelerometer;
measuring magnetic field parameters of the UPI device by a magnetometer;
processing the measured acceleration parameters to generate an initial orientation of the UPI device and processing the measured magnetic field parameters to generate an initial azimuth of the UPI device;
wherein the identifying of the first at least one object of interest in the surroundings is further based on the generated initial orientation of the UPI device and on the generated initial azimuth of the UPI device.

3. The method of claim 1, wherein the information to the user of the UPI device is provided by at least one of a loudspeaker mounted in the UPI device, an LED mounted on the external surface of the UPI device and a vibration motor mounted in the UPI device.

4. The method of claim 1, wherein the information to the user of the UPI device is provided by at least one of a screen of a handheld device, a loudspeaker of the handheld device, an earbud and a headphone.

5. The method of claim 2, wherein the information to the user of the UPI device is provided by at least one of a loudspeaker mounted in the UPI device, an LED mounted on the external surface of the UPI device and a vibration motor mounted in the UPI device.

6. The method of claim 2, wherein the information to the user of the UPI device is provided by at least one of a screen of a handheld device, a loudspeaker of the handheld device, an earbud and a headphone.

7. The method of claim 1, wherein the obtaining the general location of the UPI device using GPS signals is performed by a handheld device.

8. The method of claim 2, wherein the obtaining the general location of the UPI device using GPS signals is performed by a handheld device.

9. A method of navigating by using a universal pointing and interacting (UPI) device, the method comprises:
receiving a specified destination from a user of the UPI device;
obtaining a location of the specified destination from a features database;
obtaining a general location of the UPI device using GPS signals;
capturing a first at least one image by a camera facing a frontal direction of the UPI device;
processing the first at least one captured image to generate a first frontal visual representation for the UPI device;
identifying a first at least one object of interest in the surroundings based on the obtained general location of the UPI device and the generated first frontal visual representation for the UPI device;
obtaining a first at least one location of the identified first at least one object of interest from a features database;
estimating a first location, a first orientation and a first azimuth of the UPI device based on the obtained first at least one location of the identified first at least one object of interest;
calculating a walking path based on the estimated first location of the UPI device and based on the location of the specified destination;
generating first walking instructions based on the calculated walking path;
calculating a first pointing direction based on the calculated walking path;
generating first pointing instructions based on the first pointing direction, on the estimated first orientation and the estimated first azimuth of the UPI device;
providing the generated first pointing instructions to the user of the UPI device;
providing the generated first walking instructions to the user of the UPI device;
capturing a second at least one image by the camera facing a frontal direction of the UPI device;
processing the second at least one captured image to generate a second frontal visual representation for the UPI device;
identifying a second at least one object of interest in the surroundings based on the generated second frontal visual representation for the UPI device;
obtaining a second at least one location of the identified second at least one object of interest from the features database;
estimating a second location, a second orientation and a second azimuth of the UPI device based on the second obtained at least one location of the identified second at least one object of interest;
calculating a refined walking path based on the estimated second location of the UPI device.
generating second walking instructions based on the calculated refined walking path;
calculating a second pointing direction based on the calculated refined walking path;
generating second pointing instructions based on the first pointing direction, on the estimated second orientation and the estimated second azimuth of the UPI device;
providing the generated second pointing instructions to the user of the UPI device;
providing the generated second walking instructions to the user of the UPI device.

10. The method of claim 9, further comprising:
measuring first acceleration parameters of the UPI device by an accelerometer;
measuring first magnetic field parameters of the UPI device by a magnetometer;
processing the measured first acceleration parameters to generate an initial first orientation of the UPI device and processing the measured first magnetic field parameters to generate an initial first azimuth of the UPI device;
wherein the identifying of the first at least one object of interest in the surroundings is further based on the generated first initial orientation of the UPI device and on the generated initial first azimuth of the UPI device.

11. The method of claim 9, further comprising:
measuring second acceleration parameters of the UPI device by an accelerometer;
measuring second magnetic field parameters of the UPI device by a magnetometer;
processing the measured second acceleration parameters to generate an initial second orientation of the UPI device and processing the measured second magnetic field parameters to generate an initial second azimuth of the UPI device;
wherein the identifying of the second at least one object of interest in the surroundings is further based on the generated second initial orientation of the UPI device and on the generated initial second azimuth of the UPI device.

12. The method of claim 9, whereon the at least one of the first pointing instructions, the first walking instructions, the second pointing instructions and the second walking instructions to the user of the UPI device is provided by at least one of a loudspeaker mounted in the UPI device, an LED at the outer shell of the UPI device and a vibrating motor mounted in the UPI device.

13. The method of claim 9, wherein at least one of the first pointing instructions, the first walking instructions, the second pointing instructions and the second walking instructions to the user of the UPI device is provided by at least one of a screen of a handheld device, a loudspeaker of the handheld device, an earbud and a headphone.

14. The method of claim 8, wherein of the obtaining the general location of the UPI device using GPS signals is performed by a handheld device.
